(19) United States
(12) Patent Application Publication
(10) Pub. No.: US 2026/0273563 A1
(43) Pub. Date: Sep. 17, 2026

(54) INKJET COATING METHOD

(71) Applicant: NISSAN MOTOR CO., LTD., Yokohama-shi, Kanagawa (JP)

(72) Inventors: Kosuke TEZUKA, Kanagawa (JP); Yasuhiro FUKUYAMA, Kanagawa (JP); Tooru KOSEMURA, Kanagawa (JP); Youichi YOSHIOKA, Kanagawa (JP)

(73) Assignee: NISSAN MOTOR CO., LTD., Yokohama-shi, Kanagawa (JP)

(21) Appl. No.: 19/166,348

(22) PCT Filed: Mar. 22, 2023
(86) PCT No.: PCT/JP2023/011192

§ 371 Date: Sep. 17, 2025

(51) Int. Cl. B05B 13/00; B05B 13/04; B05D 7/00; B05D 7/14; B41J 3/407

(52) U.S. Cl. CPC B05B 13/002; B05B 13/041; B05D 7/14; B05D 7/582; B41J 3/4073

(57) ABSTRACT

In order to suppress the occurrence of the coffee ring phenomenon in the painting process of automobiles, an inkjet coating device (1) including a nozzle (11) that ejects a coating material (2) is used to apply the coating material to a coating surface (3) as a target in an inkjet coating method, in which the film thickness (t) of the peripheral edge portion (25b) of the wet coating film (25) applied to the coating surface becomes thinner as it approaches the peripheral edge (25c).

### TECHNICAL FIELD

The present invention relates to an inkjet coating method using an inkjet coating device.

### BACKGROUND ART

Conventionally, in an inkjet coating method using an inkjet coating device, it is known that the occurrence of a coffee ring phenomenon can be suppressed if, in a coating film drying process, a coating film having fluidity formed on a substrate after completion of the ejection of a film liquid by the inkjet coating device is dried under reduced pressure in an atmosphere at a temperature of 10° C. to 40° C. (Patent Document 1).

### PRIOR ART DOCUMENTS

### Patent Documents

Patent Document 1: JP2015-160176A

### SUMMARY OF INVENTION

### Problems to be Solved by Invention

In the automobile painting process, however, there is a certain amount of time, a so-called setting time, between the completion of coating with the coating material and the start of baking and drying. Therefore, even if the above conventional technique is applied during the baking and drying, the occurrence of the coffee ring phenomenon cannot be suppressed because the solvent evaporates from the wet coating film during the setting time.

A problem to be solved by the present invention is to provide an inkjet coating method that can suppress the occurrence of the coffee ring phenomenon in the automobile painting process.

### Means for Solving Problems

In an inkjet coating method using an inkjet coating device, the present invention solves the above problem by applying a coating material so that the film thickness of a peripheral edge portion of a wet coating film applied to the coating surface becomes thinner as it approaches the peripheral edge.

### Effect of Invention

According to the present invention, the occurrence of the coffee ring phenomenon in the automobile painting process can be suppressed.

### BRIEF DESCRIPTION OF DRAWINGS

FIG. 1 is a configuration diagram illustrating an embodiment of the inkjet coating device used in the inkjet coating method according to the present invention.

FIG. 2 is a perspective view illustrating an embodiment of the inkjet coating method according to the present invention.

FIG. 3A is a set of a plan view, a cross-sectional view along line X-X, and a cross-sectional view along line Y-Y illustrating a wet coating film coated by the inkjet coating method according to an embodiment of the present invention.

FIG. 3B is a set of a plan view, a cross-sectional view along line X-X, and a cross-sectional view along line Y-Y illustrating the movement trajectory of a nozzle for forming a first layer of the wet coating film of FIG. 3A.

FIG. 3C is a set of a plan view, a cross-sectional view along line X-X, and a cross-sectional view along line Y-Y illustrating the movement trajectory of a nozzle for forming a second layer of the wet coating film of FIG. 3A.

FIG. 3D is a set of a plan view, a cross-sectional view along line X-X, and a cross-sectional view along line Y-Y illustrating the movement trajectory of a nozzle for forming a third layer of the wet coating film of FIG. 3A.

FIG. 3E is a set of a plan view, a cross-sectional view along line X-X, and a cross-sectional view along line Y-Y illustrating the movement trajectory of a nozzle for forming a fourth layer of the wet coating film of FIG. 3A.

FIG. 4A is a cross-sectional view of a coating film for explaining the mechanism with which the coffee ring phenomenon occurs.

FIG. 4B is a cross-sectional view of a coating film for explaining the mechanism with which the coffee ring phenomenon is suppressed in the present invention.

FIG. 5 is a set of diagrams illustrating examples of a wet coating film and a dried coating film applied by the inkjet coating method according to the present invention and the comparative examples.

FIG. 6A is a cross-sectional view illustrating a wet coating film applied by the inkjet coating method according to another embodiment of the present invention.

FIG. 6B is a cross-sectional view illustrating a wet coating film applied by the inkjet coating method according to yet another embodiment of the present invention.

FIG. 6C is a cross-sectional view illustrating a wet coating film applied by the inkjet coating method according to still yet another embodiment of the present invention.

FIG. 7 is a set of a plan view and a cross-sectional view illustrating an example of a method for completing coating of one coating surface and then coating an adjacent coating surface by the inkjet coating method according to yet still another embodiment of the present invention.

FIG. 8A is a cross-sectional view (first layer) illustrating a method for coating a wet coating film formed on the second coating surface of FIG. 7.

FIG. 8B is a cross-sectional view (second layer) illustrating a method for coating a wet coating film formed on the second coating surface of FIG. 7.

FIG. 8C is a cross-sectional view (third layer) illustrating a method for coating a wet coating film formed on the second coating surface of FIG. 7.

FIG. 8D is a cross-sectional view (fourth layer) illustrating a method for coating a wet coating film formed on the second coating surface of FIG. 7.

### MODE(S) FOR CARRYING OUT THE INVENTION

Hereinafter, one or more embodiments of the present invention will be described with reference to the drawings. The inkjet coating method of the present embodiment is not particularly limited, but can be applied to a process of painting automobile parts such as the outer/inner panels of an automobile body and bumpers, for example, to a middle coat process, a top coat process, etc., using, for example, an automobile coating material (a thermosetting coating material with a base resin such as acrylic resin, alkyd resin, or polyester resin, which may be either a water-based coating material or an organic solvent-based coating material, which may contain color pigments and luster pigments as necessary). When painting automobile parts such as the outer/inner panels of an automobile body and bumpers, it is necessary to use a coating material with a relatively high viscosity because the surface to be painted, such as a side door or fender, is almost vertical. In that sense, the application of resist liquid to silicon wafers described in the background art and the recording head or the like of an inkjet recording device used for printing on commercially available paper media are premised on the use of low-viscosity resist liquid or ink, and are therefore not suitable for painting automobile bodies.

### Embodiment of Inkjet Coating Device

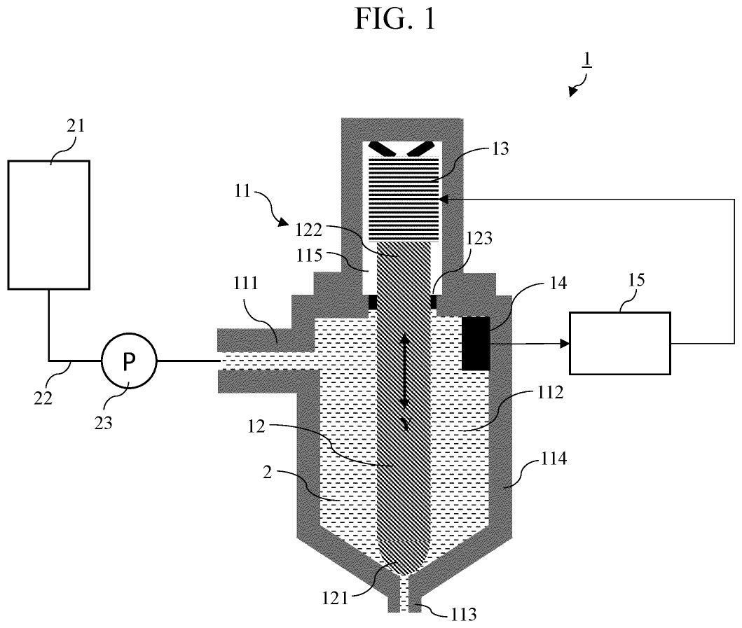

FIG. 1 is a configuration diagram illustrating an embodiment of an inkjet coating device 1 used in the inkjet coating method according to the present invention. The inkjet coating method according to the present invention is a painting method for a coating material using a so-called inkjet coating device (a machine that prints by ejecting minute droplets of ink from a fine nozzle onto paper), and is widely known by the name of “inkjet coating device.” In the present specification, therefore, the term “ink” is used for the “inkjet coating method” according to the present invention and the “inkjet coating device” used in this method. However, since the coating target relating to the present invention is an automobile part such as an outer panel/inner panel of an automobile body or a bumper, this ink actually means a “coating material for automobile painting.”

The inkjet coating device 1 of the present embodiment includes: a nozzle 11 that has an introduction section 111 for a coating material 2, a coating material chamber 112, and an ejection section 113 for the coating material 2; a needle 12 whose at least a tip portion 121 is disposed in the coating material chamber 112, wherein the tip portion 121 is provided so as to be able to reciprocate in an axial direction Y toward the ejection section 113; an actuator 13 that moves the needle 12 back and forth in the axial direction Y so that the tip portion 121 approaches the ejection section 113 when the needle 12 advances, and moves away from the ejection section 113 when the needle 12 retreats; a pressure sensor 14 that detects the pressure of the coating material 2 in the coating material chamber 112; and a control unit 15 that controls the actuator 13.

The nozzle 11 has a hollow housing 114 composed of a metal material, a resin material, or a ceramic material. The housing 114 has a side surface formed with the introduction section 111 and a tip end formed with the ejection section 113. The coating material chamber 112 is formed inside the housing. The coating material 2 is introduced from the introduction section 111 into the coating material chamber 112, and is ejected (dropped) from the ejection section 113 to the outside by being pushed by the needle 12. The inside of the housing 114 is liquid-tightly divided into the coating material chamber 112 and an actuator chamber 115 by a seal member 123.

The needle 12 is a needle-shaped rod body (rod) composed of a metal material, a resin material, or a ceramic material. The needle 12 has a tip portion 121 disposed in the coating material chamber 112 and a base end portion 122 disposed in the actuator chamber 115, and the seal member 123 is provided between them. The actuator 13 is fixed to the base end portion 122 of the needle 12. The needle 12 is provided in the housing 114 so as to be movable back and forth in the axial direction Y.

The actuator 13 is, for example, a laminate of a plurality of piezoelectric elements, and has a property of expanding and contracting in the axial direction Y in response to the voltage applied to the electrodes. The application of voltage to the actuator 13 is executed by the control unit 15, and the needle 12 can be moved back and forth in the axial direction Y by applying a voltage to the actuator 13 according to a command signal from the control unit 15. The stroke start position or the like of the needle 12 may be controlled based on the pressure of the coating material 2 in the coating material chamber 112 detected by the pressure sensor 14.

The coating material 2 in the present embodiment is contained in a coating material tank 21 and is supplied by a coating material pump 23 via a coating material pipe 22. When the inkjet coating device 1 of the present embodiment is used for painting automobile parts such as automobile bodies and bumpers, a thermosetting coating material having an acrylic resin, an alkyd resin, a polyester resin, or the like as a base resin and containing a coloring pigment or a luster pigment as necessary can be used as the automobile coating material. Either a water-based coating material or an organic solvent-based coating material may be used, and the coating material may be adjusted to a desired viscosity using a solvent. A coating material pipe may be provided to return the coating material 2 introduced into the coating material chamber 112 of the nozzle 11 to the coating material tank 21, and the coating material 2 may be circulated and supplied.

### Embodiments of Inkjet Coating Method

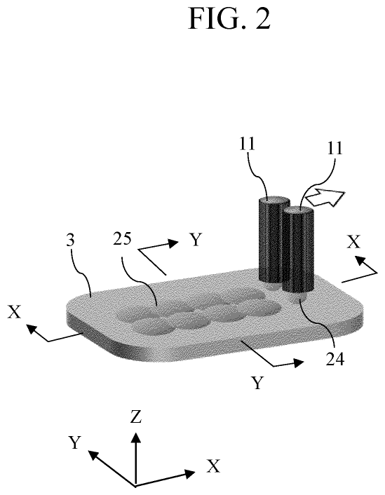

FIG. 2 is a perspective view illustrating an embodiment of the inkjet coating method according to the present invention. In the embodiment illustrated in the figure, an example is illustrated in which two nozzles 11 are provided in the above-described inkjet coating device 1 for a coating surface 3 as a target. In FIG. 2, provided that a plane parallel to the coating surface 3 is the X-Y plane and an axis perpendicular to the X-Y plane is the Z-axis, the two nozzles 11 and 11 are arranged side by side along the Y-axis direction, and the two nozzles 11 and 11 drop the coating material 2 onto the coating surface 3 while moving in a direction (X-axis direction) perpendicular to the direction in which the nozzles 11 are arranged side by side (Y-axis direction), thereby forming two rows of wet coating films 25 on the surface of the coating surface 3. The distance between the two nozzles 11 and 11 is set to a distance roughly equivalent to one droplet of the droplets 24 of the coating material 2, and as illustrated in FIG. 2, the droplets 24 of the coating material 2 dropped from the two nozzles 11 and 11 form continuous wet coating films 25 on the coating surface 3. In the present specification, for the sake of simplicity, the inkjet coating device 1 including two nozzles 11 is taken as an example, but an appropriate number of nozzles 11 can be arranged in parallel depending on the size of the coating surface 3.

In the present specification, the coating material 2, the droplets 24 of the coating material 2, the wet coating film 25, and the dried coating film 26 are used as different technical terms. That is, the liquid material from the coating material tank 21 to the coating surface 3 is collectively referred to as the coating material 2, and the granular liquid material from the ejection section 113 of the nozzle 11 to the coating surface 3 is referred to as the droplets 24 of the coating material 2. In contrast, the liquid or semi-hardened film between when the droplets 24 of the coating material 2 adhere to the coating surface 3 and when they are baked and dried is called a wet coating film 25, and the wet coating film that has been baked and hardened is called a dried coating film 26.

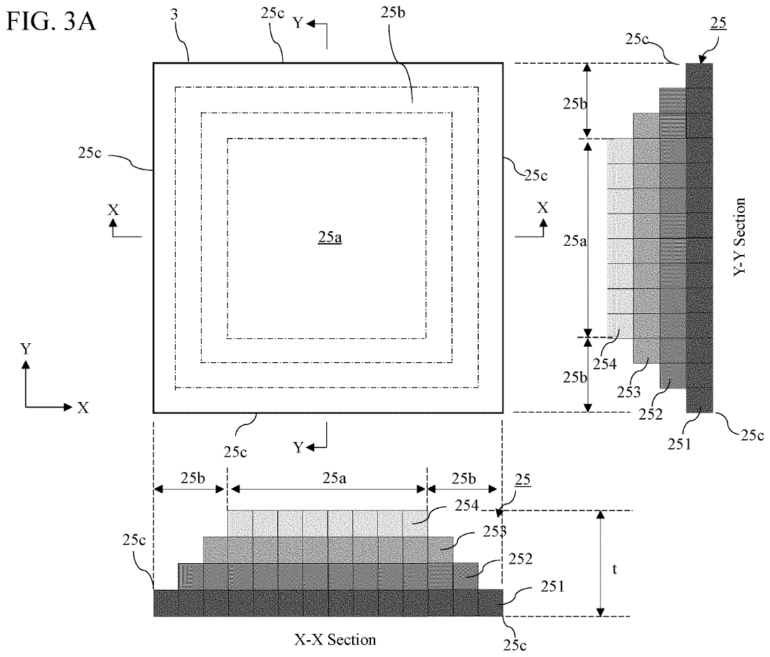

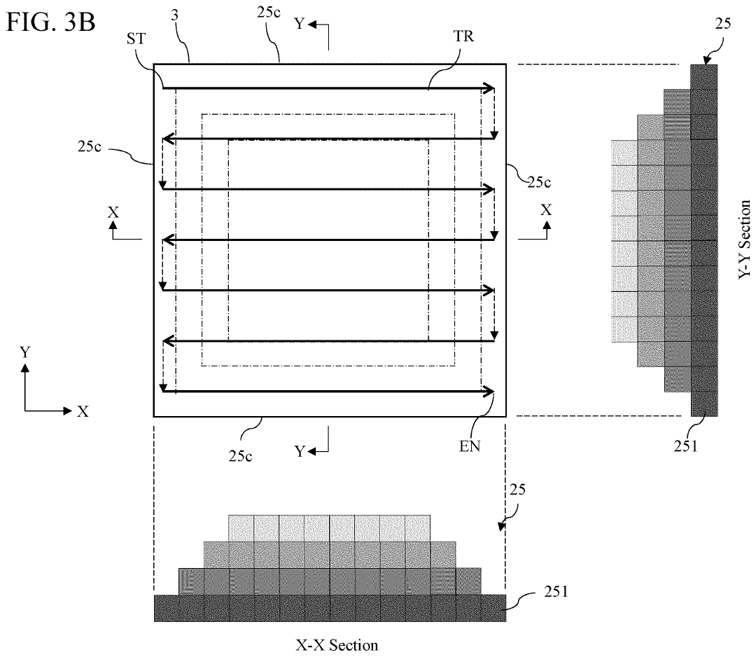

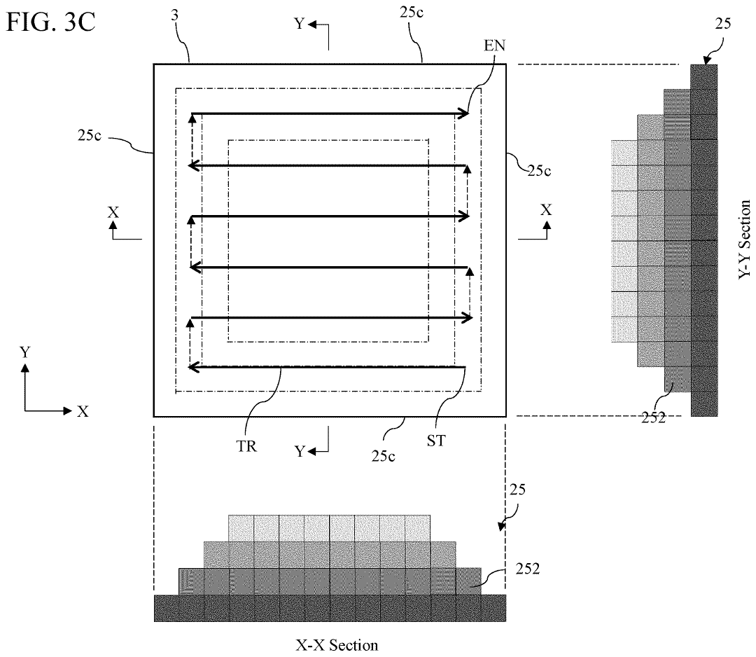

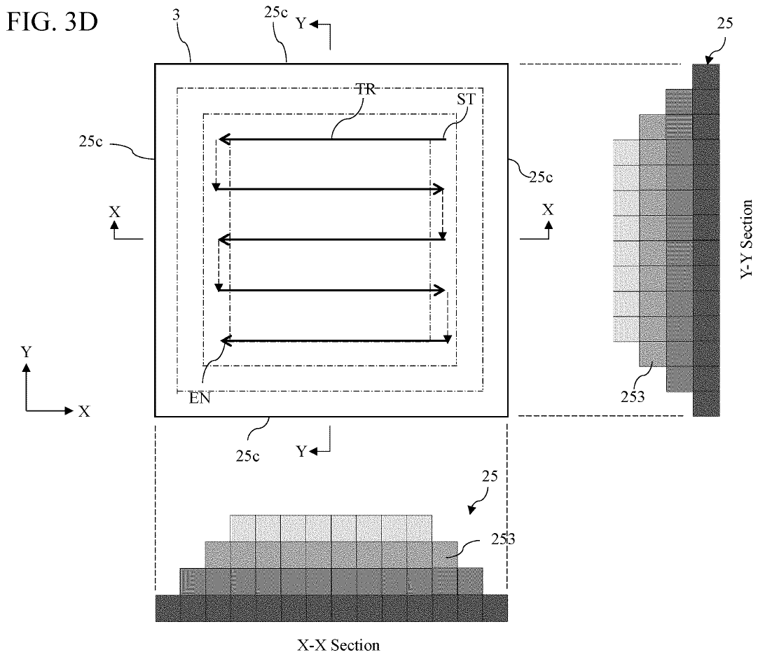

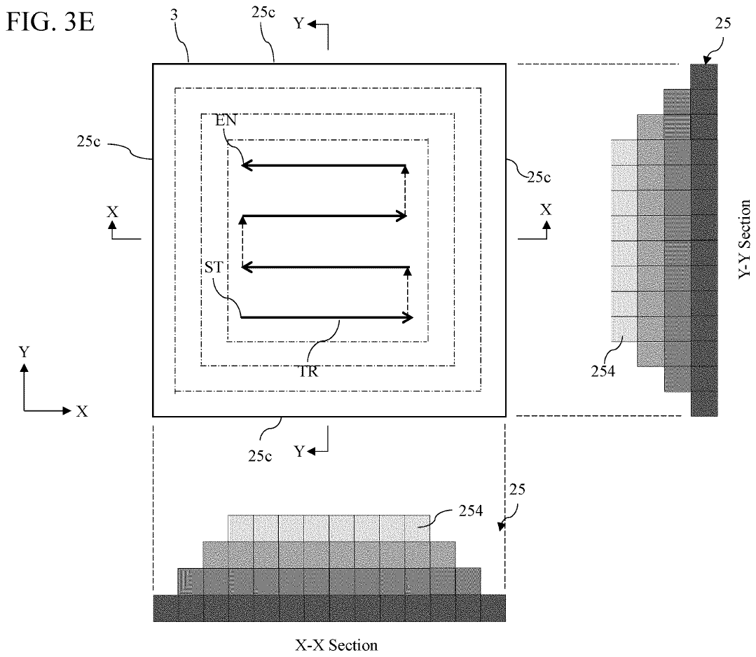

The inkjet coating method of the present embodiment is a method of applying the coating material 2 to the coating surface 3 as a target using the inkjet coating device 1 including a nozzle 11 that ejects the coating material 2, in which the coating material 2 is applied to the coating surface 3 such that a film thickness t of a peripheral edge portion 25b of the wet coating film 25 applied to the coating surface 3 becomes thinner as it approaches a peripheral edge 25c. FIG. 3A illustrates the wet coating film 25 applied by the inkjet coating method according to an embodiment of the present invention, in which the upper left figure is a plan view, the lower left figure is a cross-sectional view along line X-X (also simply referred to as an X-X cross-sectional view, hereinafter), and the upper right figure is a cross-sectional view along line Y-Y (also simply referred to as a Y-Y cross-sectional view, hereinafter). In the two cross-sectional views, the wet coating film equivalent to one droplet 24 of the coating material 2 is illustrated diagrammatically as a single rectangle.

In the plan view of FIG. 3A, the central region of the wet coating film 25 applied to the coating surface 3 is referred to as a central portion 25a, the surrounding area is referred to as a peripheral edge portion 25b, and the outermost end of the peripheral edge portion 25b is referred to as a peripheral edge 25c. In the inkjet coating method of the present embodiment, the film thickness t of the peripheral edge portion 25b of the wet coating film 25 is gradually thinner as it approaches the peripheral edge 25c in both the X-X cross section and the Y-Y cross section of the coating surface 3. This allows the wet coating film 25 as a whole to have a quadrangular pyramid shape when the coating surface 3 is a rectangle.

The wet coating film 25 of the embodiment illustrated in FIG. 3A has a four-layer structure of a first layer 251, a second layer 252, a third layer 253, and a fourth layer 254, and is formed by one coating and three overcoatings. The film thickness of each layer is set to a film thickness corresponding to one droplet of the droplets 24 of the coating material 2 ejected from the nozzle 11. No baking and drying process is inserted between the coating processes for the layers, and the coating material 2 is overcoated wet-on-wet and baked and dried when the coating process for the entire coating surface 3 is completed. When applying intermediate coating materials or top coating materials to automobile parts such as the outer/interior panels of an automobile body or bumpers, the dried coating film is generally applied so that its film thickness is 10 μm to 50 μm, although this varies depending on the location and coating specifications; therefore, also in the inkjet coating method of the present embodiment, the multi-layer structure and the number of overcoats are set accordingly.

The coating procedure for the wet coating film 25 illustrated in FIG. 3A will then be described with reference to FIG. 3B to FIG. 3E. FIG. 3B to FIG. 3E are each a set of a plan view, a cross-sectional view along line X-X, and a cross-sectional view along line Y-Y illustrating the movement trajectory of the nozzle 11 for forming the wet coating film 25 illustrated in FIG. 3A. FIG. 3B illustrates an example of a movement trajectory TR of the nozzle 11 when applying the first layer 251, with FIG. 3C for the second layer 252, FIG. 3D for the third layer 253, and FIG. 3E for the fourth layer 254. In FIGS. 3B to 3E, the thick solid arrows extending in the X-axis direction indicate the movement trajectories TR of the nozzle 11, which are those along which the droplets 24 of the coating material 2 are ejected, the thin dashed arrows extending in the Y-axis direction indicate the movement trajectories TR of the nozzle 11, which are those along which the ejection of the coating material 2 is stopped, the symbol ST indicates the movement start position of the nozzle 11, and the symbol EN indicates the movement end position of the nozzle 11. These movement trajectories TR are merely examples of the present invention and are not limited to these, and can be changed as appropriate.

The nozzle 11 is attached, for example, to a robot hand and moves along the movement trajectories TR previously taught as described below, and ON/OFF control of the coating material 2 is also performed at the same time. First, the procedure for applying the first layer 251 to the coating surface 3 will be described with reference to FIG. 3B. The application range of this first layer 251 is the entire coating surface 3 as illustrated in FIG. 3B, so for example, the upper left corner is set as the movement start position ST, the lower right corner is set as the movement end position EN, and between these movement start position ST and movement end position EN, the movement trajectories TR are set to move back and forth in the left and right directions of the X-axis while shifting by two droplets in the Y-axis direction. The movement start position ST is a position at which the droplets 24 dropped from the two nozzles 11 and 11 contact the peripheral edge 25c on the upper side and the peripheral edge 25c on the left side of the coating surface 3, and at this movement start position ST, the two nozzles 11 and 11 are oriented side by side in the Y-axis direction.

In FIG. 3B, the movement trajectory TR of a straight line heading rightward on the X-axis from the movement start position ST is a trajectory of the upper nozzle 11 of the two nozzles 11 and 11 arranged side by side in the Y-axis direction, moving along a position one droplet below the peripheral edge 25c of the upper side of the coating surface 3, and the thick solid arrow corresponds to the trajectory of the center position of the two nozzles 11 and 11 arranged side by side in the Y-axis direction. The right end point of the first row of the movement trajectory TR starting from the movement start position ST is set as a position at which the right end of the droplet 24 from the nozzle 11 touches the peripheral edge 25c of the right side of the coating surface 3, and the droplets 24 of the coating material 2 are dropped from the movement start position ST to this end point. Here, the ejection of the coating material 2 is temporarily turned off, and the two nozzles 11 and 11 arranged side by side in the Y-axis direction move downward in the Y-axis direction by the width of two droplets of the droplets 24.

The movement trajectory TR of the subsequent second row is a straight line trajectory from the right end to the left end, and the ejection of the coating material 2 is resumed at the right end and stopped again at the left end. Such an operation is repeated for the third row, fourth row, fifth row, sixth row, and seventh row. The distance in the Y-axis direction of each row is the same as the distance between the first and second rows, and is a distance corresponding to two droplets of the droplets 24. The movement end position EN is set as a position at which the droplets 24 dropped from the two nozzles 11 and 11 contact the peripheral edge 25c of the lower side and the peripheral edge 25c of the right side of the coating surface 3. The above operation completes the application of the first layer 251 of the wet coating film 25.

With reference to FIG. 3C, the application procedure for the second layer 252 will then be described. As illustrated in FIG. 3C, the coating range of the second layer 252 is narrower than the entire coating surface 3 by one droplet of the droplets 24 inward from the peripheral edge 25c. Since the movement end position EN of the first layer 251 is the lower right corner of the coating surface 3, for example, the lower right corner is set as the movement start position ST, and the upper right corner is set as the movement end position EN. Then, the nozzle 11 is moved along the movement trajectory TR to move back and forth in the left and right directions of the X-axis while shifting by two droplets in the Y-axis direction. The movement start position ST is set as a position at which the droplets 24 dropped from the two nozzles 11 and 11 contact a position one droplet of the droplets 24 inward from the peripheral edge 25c of the lower side of the coating surface 3 and a position one droplet of the droplets 24 inward from the peripheral edge 25c of the right side, and the two nozzles 11 and 11 are oriented in parallel in the Y-axis direction.

In FIG. 3C, the movement trajectory TR of a straight line heading leftward on the X-axis from the movement start position ST is a trajectory of the lower nozzle 11 of the two nozzles 11 and 11 arranged side by side in the Y-axis direction, moving along a position two droplets' width above the peripheral edge 25c of the lower side of the coating surface 3, and the thick solid arrow corresponds to the trajectory of the center positions of the two nozzles 11 and 11 arranged side by side in the Y-axis direction. The left end point of the movement trajectory TR in the first row from the bottom, which starts from the movement start position ST, is set as a position at which the left end of the droplet 24 from the nozzle 11 touches a position one droplet inward from the peripheral edge 25c of the left side of the coating surface 3, and the droplets 24 of the coating material 2 are dropped from the movement start position ST to this end point. Here, the ejection of coating material 2 is temporarily turned off, and the two nozzles 11 and 11 arranged side by side in the Y-axis direction move upward in the Y-axis direction by the width of two droplets 24 of the droplets 24.

The movement trajectory TR of the subsequent second row from the bottom is a straight line trajectory from the left end to the right end, and the ejection of the coating material 2 is resumed at the left end and stopped again at the right end. Such an operation is repeated for the third row from the bottom, the fourth row from the bottom, the fifth row from the bottom, and the sixth row from the bottom. The distance in the Y-axis direction of each row is the same as the distance between the first row from the bottom and the second row from the bottom, and is a distance corresponding to two droplets of the droplets 24. The movement end position EN is set as a position at which the droplets 24 dropped from the two nozzles 11 and 11 contact a position one droplet inward from the peripheral edge 25c of the upper side of the coating surface 3 and a position one droplet inward from the peripheral edge 25c of the right side. The above operation completes the application of the second layer 252 of the wet coating film 25.

With reference to FIG. 3D, the application procedure for the third layer 253 will then be described. As illustrated in FIG. 3D, the coating range of the third layer 253 is narrower than the entire coating surface 3 by two droplets of the droplets 24 inward from the peripheral edge 25c. Since the movement end position EN of the second layer 252 is the upper right corner of the coating surface 3, for example, the upper right corner is set as the movement start position ST, and the lower left corner is set as the movement end position EN. Then, the nozzle 11 is moved along the movement trajectory TR to move back and forth in the left and right directions of the X-axis while shifting by two droplets in the Y-axis direction. The movement start position ST is set as a position at which the droplets 24 dropped from the two nozzles 11 and 11 contact a position two droplets of the droplets 24 inward from the peripheral edge 25c of the upper side of the coating surface 3 and a position two droplets of the droplets 24 inward from the peripheral edge 25c of the right side, and the two nozzles 11 and 11 are oriented in parallel in the Y-axis direction.

In FIG. 3D, the movement trajectory TR of a straight line heading leftward on the X-axis from the movement start position ST is a trajectory of the upper nozzle 11 of the two nozzles 11 and 11 arranged side by side in the Y-axis direction, moving along a position three droplets' width below the peripheral edge 25c of the upper side of the coating surface 3, and the thick solid arrow corresponds to the trajectory of the center positions of the two nozzles 11 and 11 arranged side by side in the Y-axis direction. The left end point of the movement trajectory TR in the first row from the bottom, which starts from the movement start position ST, is set as a position at which the left end of the droplet 24 from the nozzle 11 touches a position two droplets inward from the peripheral edge 25c of the left side of the coating surface 3, and the droplets 24 of the coating material 2 are dropped from the movement start position ST to this end point. Here, the ejection of coating material 2 is temporarily turned off, and the two nozzles 11 and 11 arranged side by side in the Y-axis direction move downward in the Y-axis direction by the width of two droplets 24 of the droplets 24.

The movement trajectory TR of the subsequent second row is a straight line trajectory from the left end to the right end, and the ejection of the coating material 2 is resumed at the left end and stopped again at the right end. Such an operation is repeated for the third row, the fourth row, and the fifth row. The distance in the Y-axis direction of each row is the same as the distance between the first row and the second row, and is a distance corresponding to two droplets of the droplets 24. The movement end position EN is set as a position at which the droplets 24 dropped from the two nozzles 11 and 11 contact a position two droplets inward from the peripheral edge 25c of the lower side of the coating surface 3 and a position two droplets inward from the peripheral edge 25c of the left side. The above operation completes the application of the third layer 253 of the wet coating film 25.

With reference to FIG. 3E, the application procedure for the fourth layer 254, which is the uppermost layer, will then be described. As illustrated in FIG. 3E, the coating range of the fourth layer 254 is narrower than the entire coating surface 3 by three droplets of the droplets 24 inward from the peripheral edge 25c. Since the movement end position EN of the third layer 253 is the lower left corner of the coating surface 3, for example, the lower left corner is set as the movement start position ST, and the upper left corner is set as the movement end position EN. Then, the nozzle 11 is moved along the movement trajectory TR to move back and forth in the left and right directions of the X-axis while shifting by two droplets in the Y-axis direction. The movement start position ST is set as a position at which the droplets 24 dropped from the two nozzles 11 and 11 contact a position three droplets of the droplets 24 inward from the peripheral edge 25c of the lower side of the coating surface 3 and a position three droplets of the droplets 24 inward from the peripheral edge 25c of the left side, and the two nozzles 11 and 11 are oriented in parallel in the Y-axis direction.

In FIG. 3E, the movement trajectory TR of a straight line heading rightward on the X-axis from the movement start position ST is a trajectory of the lower nozzle 11 of the two nozzles 11 and 11 arranged side by side in the Y-axis direction, moving along a position four droplets' width above the peripheral edge 25c of the lower side of the coating surface 3, and the thick solid arrow corresponds to the trajectory of the center positions of the two nozzles 11 and 11 arranged side by side in the Y-axis direction. The right end point of the movement trajectory TR in the first row from the bottom, which starts from the movement start position ST, is set as a position at which the right end of the droplet 24 from the nozzle 11 touches a position three droplets inward from the peripheral edge 25c of the right side of the coating surface 3, and the droplets 24 of the coating material 2 are dropped from the movement start position ST to this end point. Here, the ejection of coating material 2 is temporarily turned off, and the two nozzles 11 and 11 arranged side by side in the Y-axis direction move upward in the Y-axis direction by the width of two droplets 24 of the droplets 24.

The movement trajectory TR of the subsequent second row from the bottom is a straight line trajectory from the right end to the left end, and the ejection of the coating material 2 is resumed at the right end and stopped again at the left end. Such an operation is repeated for the third row from the bottom and the fourth row from the bottom. The distance in the Y-axis direction of each row is the same as the distance between the first row from the bottom and the second row from the bottom, and is a distance corresponding to two droplets of the droplets 24. The movement end position EN is set as a position at which the droplets 24 dropped from the two nozzles 11 and 11 contact a position three droplets inward from the peripheral edge 25c of the upper side of the coating surface 3 and a position three droplets inward from the peripheral edge 25c of the left side. The above operation completes the application of the fourth layer 254 of the wet coating film 25, and the wet coating film 25 is thus formed by the inkjet coating method of the present embodiment.

### Mechanism of Suppressive Action for Coffee Ring Phenomenon

In the inkjet coating method of the present embodiment, the occurrence of the coffee ring phenomenon is suppressed by applying the coating material 2 so that the film thickness t of the peripheral edge portion 25b of the wet coating film 25 applied to the coating surface 3 becomes thinner as it approaches the peripheral edge 25c. The mechanism of the suppressive action will now be described.

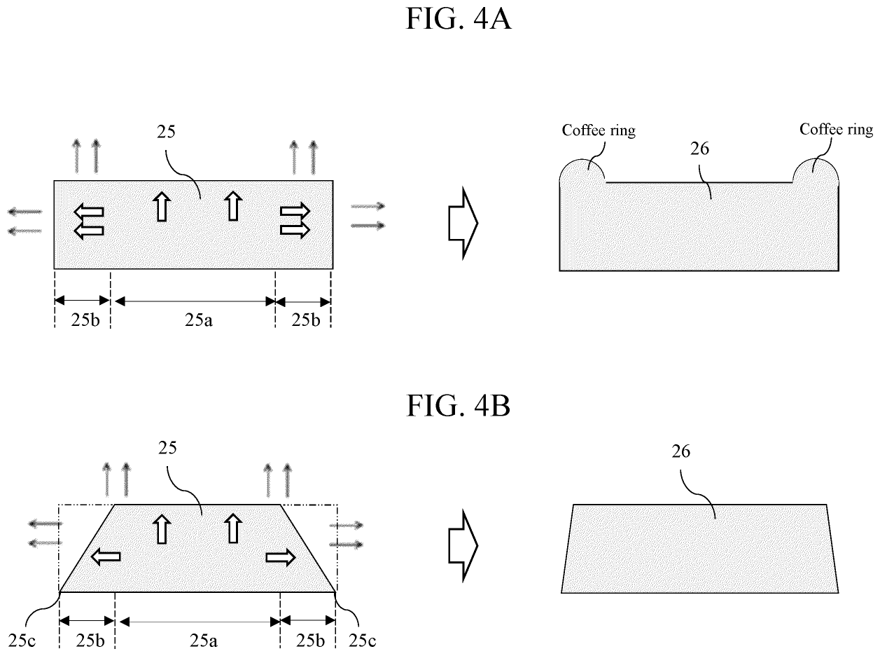

FIG. 4A is a cross-sectional view of a coating film for explaining the mechanism with which the coffee ring phenomenon occurs. The left diagram of FIG. 4A illustrates a wet coating film 25, and the right diagram illustrates a dried coating film 26 which has been baked and dried. The wet coating film 25 illustrated in the left diagram of FIG. 4A contains a volatile solvent, so the solvent of the coating material 2 evaporates from the wet coating film 25. At this time, the peripheral edge portion 25b of the wet coating film 25 has a larger contact area with the air than the central portion 25a, so the evaporation rate of the solvent is relatively fast. Accordingly, a liquid flow occurs inside the wet coating film 25 from the central portion 25a to the peripheral edge portion 25b, and particles such as solutes present in the central portion 25a move to the peripheral edge portion 25b of the wet coating film 25. Then, the particles such as solutes that have moved to the peripheral edge portion 25b accumulate there due to the pinning effect until baking and drying, and the peripheral edge portion 25b bulges in a ring shape, which is called the coffee ring phenomenon, occurs in the dried coating film 26 illustrated in the right diagram of FIG. 4A. The occurrence of such a coffee ring phenomenon impairs the smoothness of the surface of the dried coating film 26, and is a major problem when the inkjet coating device 1 is applied to automobile painting.

FIG. 4B is a cross-sectional view of a coating film to explain the mechanism for suppressing the occurrence of the coffee ring phenomenon in the inkjet coating method of the present embodiment. The left diagram of FIG. 4B illustrates the wet coating film 25, and the right diagram of FIG. 4B illustrates the dried coating film 26 which has been baked and dried. The wet coating film 25 of the present embodiment illustrated in the left diagram of FIG. 4B contains a volatile solvent, so the solvent of the coating material 2 evaporates from the wet coating film 25. In addition, although the peripheral edge portion 25b of the wet coating film 25 has a thinner film thickness as it approaches the peripheral edge 25c, the contact area with the air is larger than that of the central portion 25a, so the evaporation rate of the solvent is relatively faster. Therefore, a liquid flow occurs inside the wet coating film 25 from the central portion 25a to the peripheral edge portion 25b, and particles such as solutes present in the central portion 25a move to the peripheral edge portion 25b of the wet coating film 25.

Fortunately, however, in the wet coating film 25 of the present embodiment, the film thickness of the peripheral edge portion 25b becomes thinner as it approaches the peripheral edge 25c, and the amount of liquid in the coating film at the peripheral edge portion 25b is small (the range in which the amount of liquid has decreased is illustrated by a two-dot chain line in FIG. 4B); therefore, even when the solute or the like inside the wet coating film 25 moves to the peripheral edge portion 25b as the solvent evaporates, the amount of liquid does not reach a level sufficient to cause a coffee ring. As a result, the occurrence of the coffee ring phenomenon can be suppressed as illustrated in the right diagram of FIG. 4B.

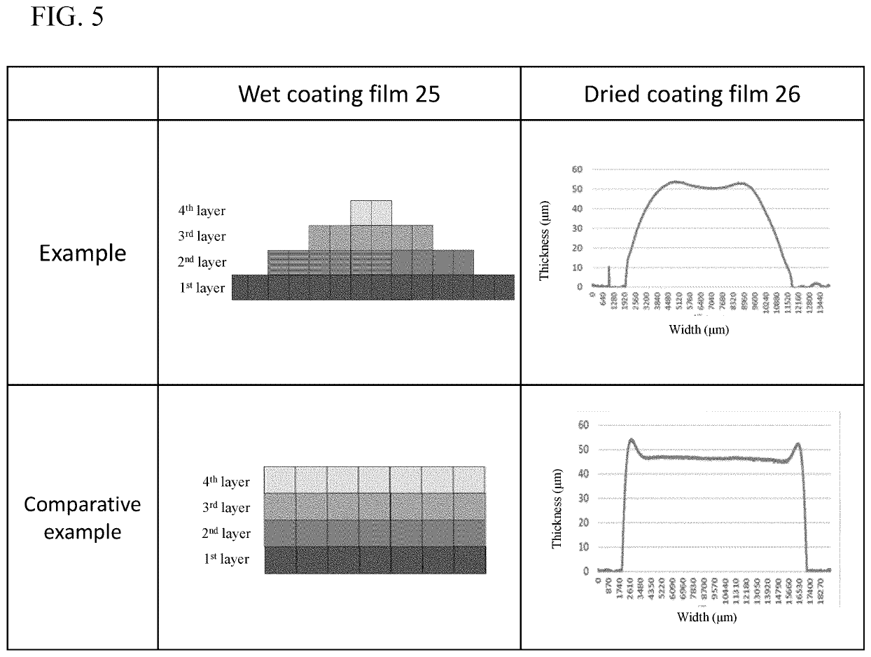

FIG. 5 is a set of diagrams illustrating examples of a wet coating film 25 and a dried coating film 26 applied by the inkjet coating method according to the present invention and the comparative examples. The wet coating film 25 according to the example is an example of a coating film in which the first layer is coated with 14 droplets in terms of the droplets 24, the second layer with 10 droplets, the third layer with 6 droplets, and the fourth layer with 2 droplets, and the peripheral edge portion 25b is gradually thinner as it approaches the peripheral edge 25c. The cross-sectional profile of the dried coating film 26 obtained by baking and drying this wet coating film 25 is illustrated in the right diagram. The peripheral edge portion of the dried coating film 26 is smoothly curved, and the coffee ring phenomenon was not observed. In contrast, in the comparative example, the same coating material was used, and seven droplets of coating film in terms of the droplets 24 were applied from the first to fourth layers so that the peripheral edges 25c of each layer were vertically aligned. The cross-sectional profile of the dried coating film 26 obtained by baking and drying this wet coating film 25 is illustrated in the right figure, and a very sharp coffee ring phenomenon was observed.

### Modification Examples

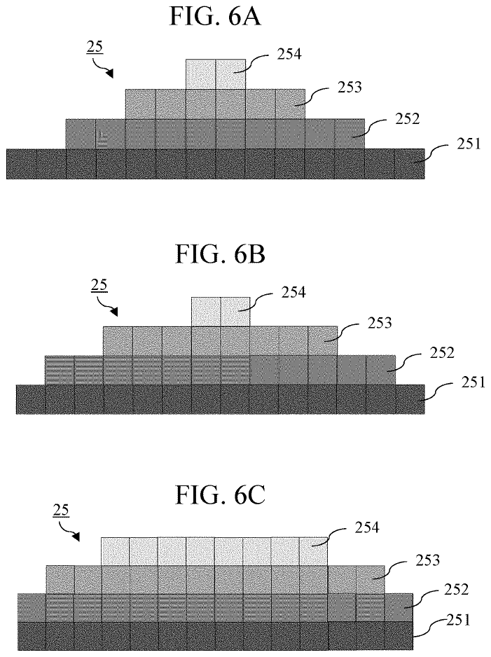

The inkjet coating method of the present embodiment can be modified within an appropriate range to suppress the occurrence of the coffee ring phenomenon by the mechanism of suppressive action as described above. Modification examples of the present embodiment will be described with reference to FIGS. 6A to 6C.

In the wet coating film 25 illustrated in FIG. 3A, for example, overcoatings are performed for the peripheral edge portion 25b so that the height of an adjacent peripheral edge portion having a different film thickness of the wet coating film 25, that is, the height of each layer from the first layer 251 to the fourth layer 254, is equivalent to one droplet in terms of the droplets 24, but the overcoatings may be performed so that the height of each layer is equivalent to two or more droplets or is a different height, or a combination of these may be used.

Also, in the wet coating film 25 illustrated in FIG. 3A, overcoatings are performed for the peripheral edge portion 25b so that the width of a peripheral edge portion having the same film thickness of the wet coating film 25 (the width of a step of steps in the cross-sectional view), that is, the length by which the lower layer protrudes from the upper layer in two adjacent layers, is equivalent to one droplet in terms of the droplets 24, but the overcoatings may be performed so that the width is equivalent to two or more droplets. FIG. 6A is a cross-sectional view of a wet coating film 25 applied by the inkjet coating method according to another embodiment of the present invention. In the wet coating film 25 of this example, the first layer 251 has a width equivalent to 14 droplets in terms of the droplets 24, the second layer 252 has a width equivalent to 10 droplets, the third layer 253 has a width equivalent to 6 droplets, and the fourth layer 254 has a width equivalent to 2 droplets.

In the embodiments illustrated in FIGS. 3A and 6A, the protruding width (length) of each layer is the same for all layers, such as 1 droplet in FIGS. 3A and 2 droplets in FIG. 6A, but may be different widths. Furthermore, in this case, the width of each layer may decrease as it approaches the peripheral edge 25c of the wet coating film 25. FIG. 6B is a cross-sectional view illustrating a wet coating film 25 applied by the inkjet coating method according to yet another embodiment of the present invention. In the wet coating film 25 of this example, the first layer 251 has a width equivalent to 14 droplets in terms of the droplets 24, the second layer 252 has a width equivalent to 12 droplets, the third layer 253 has a width equivalent to 8 droplets, and the fourth layer 254 has a width equivalent to 2 droplets. Accordingly, the difference in width between the first layer 251 and the second layer 252 is one droplet on one side, the difference in width between the second layer 252 and the third layer 253 is two droplets on one side, and the difference in width between the fourth layer 254 and the third layer 253 is three droplets on one side. Thus, the width decreases as it approaches the peripheral edge 25c.

Furthermore, in the inkjet coating method of the present embodiment, the film thickness t of the peripheral edge portion 25b of the wet coating film 25 is formed to become thinner as it approaches the peripheral edge 25c, but the film thickness of the wet coating film in a region of a predetermined width from the peripheral edge 25c toward the inside may be set to a predetermined value or more. FIG. 6C is a cross-sectional view of a wet coating film 25 applied by the inkjet coating method according to still yet another embodiment of the present invention. In the embodiment illustrated in FIG. 3A, etc., the film thickness of the peripheral edge 25c of the wet coating film 25 is equivalent to one droplet in terms of the droplets 24, but in the embodiment illustrated in FIG. 6C, the film thickness of the peripheral edge 25c of the wet coating film 25 is equivalent to two droplets in terms of the droplets 24. Thus, the film thickness of the region of a predetermined width from the peripheral edge 25c toward the inside may be equivalent to two or more droplets in terms of the droplets 24.

### Connection of Two Coating Surfaces

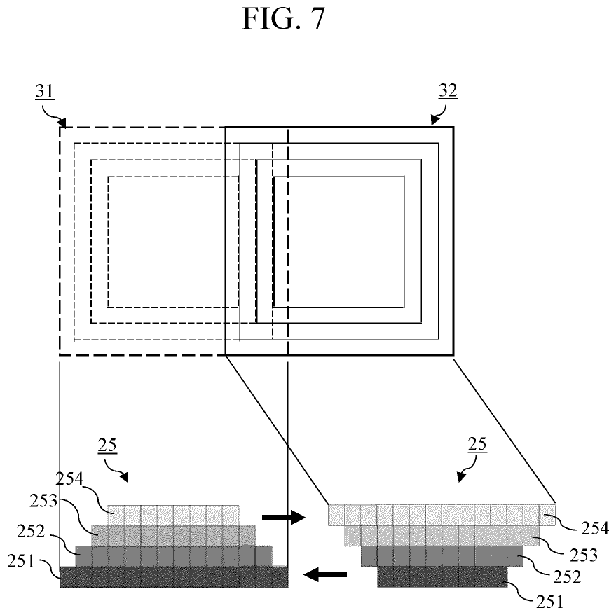

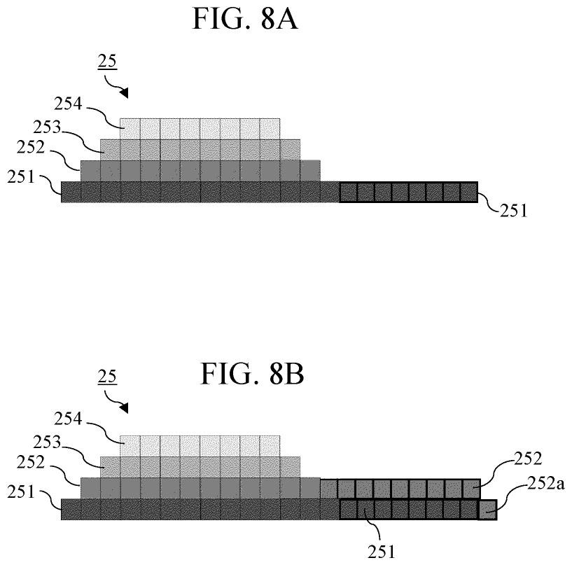

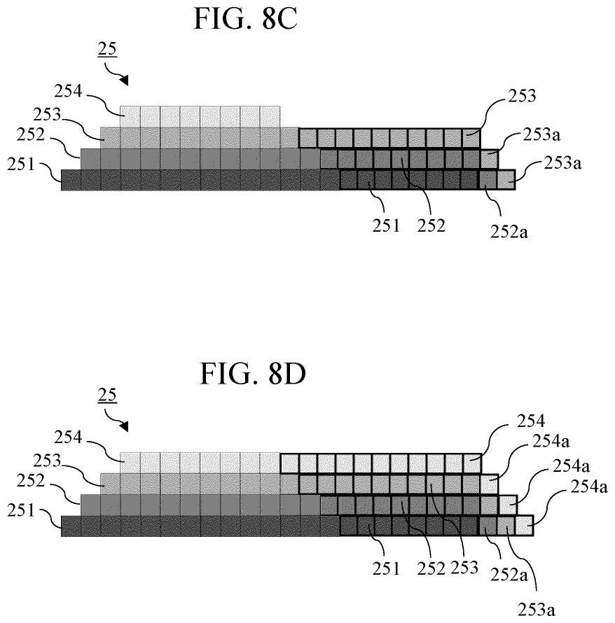

When the coating surface 3 has a large area as in an automobile body, it may be divided into several regions, and the coating material 2 may be applied to the coating surfaces 31, 32, . . . of respective regions in sequence. FIG. 7 is a set of a plan view and a cross-sectional view of a wet coating film 25, illustrating an example of a coating method in which the coating of a second coating surface 32 is started after the coating of a first coating surface 31 is completed and before baking and drying. The first coating surface 31 is illustrated by a dashed line on the left side of FIG. 7, and the second coating surface 32 is illustrated by a solid line on the right side of FIG. 7. The cross-sectional view of the wet coating film 25 of the second coating surface 32 is illustrated to be shifted slightly to the right to make the cross-sectional structure easier to understand. FIGS. 8A to 8D are cross-sectional views illustrating the coating procedure for the wet coating film 25 formed on the second coating surface 32, which is continuous with the first coating surface 31 of FIG. 7. FIG. 8A illustrates the coating procedure for the first layer 251, FIG. 8B illustrates the coating procedure for the second layer 252, FIG. 8C illustrates the coating procedure for the third layer 253, and FIG. 8D illustrates the coating procedure for the fourth layer 254.

In the inkjet coating method of the present embodiment, as illustrated in the cross-sectional view at the bottom of FIG. 7, the coating material 2 is applied to the second coating surface 32 adjacent to the first coating surface 31 so that the vertical cross section of the wet coating film 25 applied to the second coating surface 32 is inverted upside down relative to the vertical cross section of the wet coating film 25 formed on the first coating surface 31. That is, since the wet coating film 25 applied to the first coating surface 31 illustrated on the left side of FIG. 7 has a quadrangular pyramid shape with 14 drops of the first layer 251, 12 drops of the second layer 252, 10 drops of the third layer 253, and 8 drops of the fourth layer 254, the coating material 2 is applied to the second coating surface 32 so that the wet coating film 25 has a vertical cross-sectional shape that is inverted from the first layer 251, i.e., an inverted quadrangular pyramid shape with 8 drops of the first layer 251, 10 drops of the second layer 252, 12 drops of the third layer 253, and 14 drops of the fourth layer 254.

The procedure for applying the first layer 251 to the fourth layer 254 to the second coating surface 32 will be described with reference to FIGS. 8A to 8D. First, as illustrated in FIG. 8A, eight drops for the first layer 251 are applied to the second coating surface 32, continuing from the right end of the first layer 251 of the wet coating film 25 formed on the first coating surface 31 on the left side.

Then, as illustrated in FIG. 8B, ten drops for the second layer 252 are applied to the second coating surface 32, continuing from the right end of the second layer 252 of the wet coating film 25 formed on the first coating surface 31 on the left side. Here, nine drops out of the ten drops for the applied second layer 252 are applied onto the first layer 251 of the wet coating film 25 formed on the first coating surface 31 on the left side and onto the first layer 251 applied in FIG. 8A, but one drop at the right end (indicated by the symbol 252a) is applied to the right end of the first layer 251 because there is no first layer 251 below it.

Subsequently, as illustrated in FIGS. 8C, 12 drops for the third layer 253 are applied to the second coating surface 32, continuing from the right end of the third layer 253 of the wet coating film 25 formed on the first coating surface 31 on the left side. Here, 10 drops out of the 12 drops for the applied third layer 253 are applied onto the second layer 252 of the wet coating film 25 formed on the first coating surface 31 on the left side and onto the second layer 252 applied in FIG. 8B, but two drops at the right end (indicated by the symbol 253a) are applied to the right end of the first layer 251 and the right end of the second layer 252, respectively, because there is no first layer 251 or second layer 252 below them.

Finally, as illustrated in FIGS. 8D, 14 drops for the fourth layer 254 are applied to the second coating surface 32, continuing from the right end of the fourth layer 254 of the wet coating film 25 formed on the first coating surface 31 on the left side. Here, 11 drops out of the 14 drops for the applied fourth layer 254 are applied onto the third layer 253 of the wet coating film 25 formed on the first coating surface 31 on the left side and onto the third layer 253 applied in FIG. 8C, but three drops at the right end (indicated by the symbol 254a) are applied to the right end of the first layer 251, the right end of the second layer 252, and the right end of the third layer 253, respectively, because there is no first layer 251, second layer 252, or third layer 253 below them.

The above operations allow the wet coating film 25 to be formed on the second coating surface 32, continuing from the wet coating film 25 formed on the first coating surface 31, but since the connecting portions of the two wet coating films 25 and 25 have vertical cross-sectional shapes that are inverted from each other, the thickness of the wet coating films 25 after connection is uniform, resulting in good surface smoothness.

### Actions/Effects of Embodiments

As described above, according to the inkjet coating method of the present embodiment, in an inkjet coating method for applying a coating material 2 to a coating surface 3 as a target using an inkjet coating device 1 including a nozzle 11 for ejecting the coating material 2, the coating material 2 is applied so that a film thickness t of a peripheral edge portion 25b of a wet coating film 25 applied to the coating surface 3 becomes thinner as it approaches a peripheral edge 25c; therefore, due to the mechanism of action described with reference to FIG. 4B, the occurrence of the coffee ring phenomenon can be suppressed even if there is an interval such as a setting time between the end of application and the start of baking and drying as in the automobile painting process.

Moreover, according to the inkjet coating method of the present embodiment, the coating material 2 is applied so that, in the peripheral edge portion 25b of the wet coating film 25, a height of an adjacent peripheral edge portion having a different film thickness of the wet coating film 25 is equivalent to a predetermined number of droplets in terms of droplets 24 of the coating material 2 ejected from the nozzle 11; therefore, the inclination angle of the peripheral edge portion 25b of the wet coating film 25 can be set to a desired angle.

Furthermore, according to the inkjet coating method of the present embodiment, the coating material 2 is applied so that, in the peripheral edge portion 25b of the wet coating film 25, a width of the peripheral edge portion having the same film thickness of the wet coating film 25 is equivalent to a predetermined number of droplets in terms of the droplets 24 of the coating material 2 ejected from the nozzle 11; therefore, the inclination angle of the peripheral edge portion 25b of the wet coating film 25 can be set to a desired angle.

In addition, according to the inkjet coating method of the present embodiment, the coating material 2 is applied so that, in the peripheral edge portion 25b of the wet coating film 25, a width of the peripheral edge portion 25 having the same film thickness of the wet coating film 25 is equivalent to a different number of droplets in terms of the droplets 24 of the coating material 25 ejected from the nozzle 11; therefore, the inclination angle of the peripheral edge portion 25b of the wet coating film 25 can be set to a desired angle.

Moreover, according to the inkjet coating method of the present embodiment, the coating material 2 is applied so that a width of the peripheral edge portion having the same film thickness of the wet coating film 25 decreases as the number of droplets in terms of the droplets 24 of the coating material 25 ejected from the nozzle 11; therefore, the inclination angle of the peripheral edge portion 25b of the wet coating film 25 can be set to a small angle, and the occurrence of the coffee ring phenomenon can be further suppressed.

Furthermore, according to the inkjet coating method of the present embodiment, the coating material 2 is applied so that, in the peripheral edge portion 25b of the wet coating film 25, a region of a predetermined width from the peripheral edge 25c has a predetermined value or more of the film thickness of the wet coating film 25; therefore, the strength of the peripheral edge portion 25b of the wet coating film 25 can be increased.

In addition, according to the inkjet coating method of the present embodiment, this method includes: ejecting the coating material 2 from the nozzle 11 to form a first layer 251 of the wet coating film 25 on the coating surface 3; then forming a second layer 252 of the wet coating film 25 on the first layer 251 of the wet coating film 25; and repeating this coating sequentially to an uppermost layer; therefore, natural drying (evaporation of a volatile solvent) proceeds from the bottom layer onwards. As a result, the occurrence of the coffee ring phenomenon can be further suppressed.

Moreover, according to the inkjet coating method of the present embodiment, the coating material 2 is applied so that, for another coating surface 32 adjacent to the coating surface 31, a vertical cross section of the wet coating film 25 is inverted upside down; therefore, the film thickness of the wet coating film 25 after connection is uniform and the surface smoothness is satisfactory.

Furthermore, according to the inkjet coating method of the present embodiment, the coating material 2 is applied to an automobile body or automobile part; therefore, the usage efficiency of the coating material 2 is significantly improved and the scattering of coating material dust is also significantly reduced, which remarkably improves the working environment.

### DESCRIPTION OF REFERENCE NUMERALS

1 . . . Inkjet coating device
   11 . . . Nozzle
      111 . . . Introduction section
      112 . . . Coating material chamber
      113 . . . Ejection section
      114 . . . Housing
   12 . . . Needle
      121 . . . Tip portion
      122 . . . Base end portion
      123 . . . Sal member
   13 . . . Actuator
   14 . . . Pressure sensor
   15 . . . Control unit
2 . . . Coating material
   21 . . . Coating material tank
   22 . . . Coating material pipe
   23 . . . Coating material pump
   24 . . . Droplet
   25 . . . Wet coating film
      25a . . . Central portion
      25b . . . Peripheral edge portion
      25c . . . Peripheral edge
      251 . . . First layer
      252 . . . Second layer
      253 . . . Third layer
      254 . . . Fourth layer
   26 . . . Dried coating film
3 . . . Coating surface
   31 . . . First coating surface
   32 . . . Second coating surface

1.-9. (canceled)

10. An inkjet coating method for applying a coating material to a coating surface as a target using an inkjet coating device including a nozzle for ejecting the coating material, the inkjet coating method comprising
applying the coating material so that a film thickness of a peripheral edge portion of a wet coating film applied to the coating surface becomes thinner as it approaches a peripheral edge,
wherein the coating material is applied so that, in the peripheral edge portion of the wet coating film, a width of the peripheral edge portion having a same film thickness of the wet coating film is equivalent to a predetermined number of droplets in terms of droplets of the coating material ejected from the nozzle.

11. An inkjet coating method for applying a coating material to a coating surface as a target using an inkjet coating device including a nozzle for ejecting the coating material, the inkjet coating method comprising
applying the coating material so that a film thickness of a peripheral edge portion of a wet coating film applied to the coating surface becomes thinner as it approaches a peripheral edge,
wherein the coating material is applied so that, in the peripheral edge portion of the wet coating film, a width of the peripheral edge portion having a same film thickness of the wet coating film is equivalent to a different number of droplets in terms of droplets of the coating material ejected from the nozzle.

12. The inkjet coating method according to claim 11, wherein the coating material is applied so that a width of the peripheral edge portion having a same film thickness of the wet coating film decreases as a number of droplets in terms of droplets of the coating material ejected from the nozzle.

13. The inkjet coating method according to claim 10, wherein the coating material is applied so that, in the peripheral edge portion of the wet coating film, a height of an adjacent peripheral edge portion having a different film thickness of the wet coating film is equivalent to a predetermined number of droplets in terms of droplets of the coating material ejected from the nozzle.

14. The inkjet coating method according to claim 10, wherein the coating material is applied so that, in the peripheral edge portion of the wet coating film, a region of a predetermined width from the peripheral edge has a predetermined value or more of the film thickness of the wet coating film.

15. The inkjet coating method according to claim 10, comprising:
ejecting the coating material from the nozzle to form a first layer of the wet coating film on the coating surface;
then forming a second layer of the wet coating film on the first layer of the wet coating film; and
repeating this coating sequentially to an uppermost layer.

16. The inkjet coating method according to claim 10, wherein the coating material is applied so that, for another coating surface adjacent to the coating surface, a vertical cross section of the wet coating film is inverted upside down.

17. An automobile painting method comprising
applying the coating material to an automobile body or an automobile part by the inkjet coating method according to claim 10.

18. The inkjet coating method according to claim 11, wherein the coating material is applied so that, in the peripheral edge portion of the wet coating film, a height of an adjacent peripheral edge portion having a different film thickness of the wet coating film is equivalent to a predetermined number of droplets in terms of droplets of the coating material ejected from the nozzle.

19. The inkjet coating method according to claim 11, wherein the coating material is applied so that, in the peripheral edge portion of the wet coating film, a region of a predetermined width from the peripheral edge has a predetermined value or more of the film thickness of the wet coating film.

20. The inkjet coating method according to claim 11, comprising:
ejecting the coating material from the nozzle to form a first layer of the wet coating film on the coating surface;
then forming a second layer of the wet coating film on the first layer of the wet coating film; and
repeating this coating sequentially to an uppermost layer.

21. The inkjet coating method according to claim 11, wherein the coating material is applied so that, for another coating surface adjacent to the coating surface, a vertical cross section of the wet coating film is inverted upside down.

22. An automobile painting method comprising
applying the coating material to an automobile body or an automobile part by the inkjet coating method according to claim 11.
